(19) United States
(12) Patent Application Publication
(10) Pub. No.: US 2026/0328047 A1
(43) Pub. Date: Oct. 22, 2026

(54) SPACER FOR INSULATED GLASS UNITS COMPRISING A POLYMERIC GLASS PANE

(71) Applicant: Nxlite Technologies Inc., Canton Township, MI (US)

(72) Inventors: Nazir Pyarali KHERANI, Toronto (CA); JOSE NUNEZ-REGUEIRO, Ann Arbor, MI (US); NAVID SOHEILNIA, Richmond Hill (CA); EHSAN PEYMANNIA, North York (CA); ALEXEY KRASNOV, Canton, MI (US)

(21) Appl. No.: 19/645,533

(22) Filed: Apr. 13, 2026

Related U.S. Application Data
(60) Provisional application No. 63/789,627, filed on Apr. 16, 2025.

(51) Int. Cl. E06B 3/663

(52) U.S. Cl. CPC E06B 3/66366; E06B 3/66352; E06B 3/66361

(57) ABSTRACT

The present disclosure provides a spacer for an insulated glass unit comprising one inner and one outer pane and at least one central pane for enhanced thermal insulation of existing residential and commercial windows. The spacer comprises at least one pressure-relief cavity designed to redistribute the excessive pressure exerted during the deformation of a polymeric central pane due to its high coefficient of thermal expansion compared to that of glass, thus preventing structural damage to the unit. The spacer may comprise a compressive accommodating member comprising the cavity and enabling additional relief of the excessive deformation. The invention may be used in different spacer designs, both commercially available on the current market and developed in the future.

### FIELD OF INVENTION

The present disclosure relates to a window spacer for insulating glass units (IGUs) comprising one exterior (outermost) and one interior (innermost) glass pane and at least one polymeric glass center pane. The spacer is designed to accommodate the deformation caused by the greater coefficient of thermal expansion of the at least one polymeric glass center pane compared to that of the glass panes without exerting significant localized pressure on the adjacent structural elements of the multi-pane IGU.

### BACKGROUND

The use of thermally insulating glass units (IGUs) is on the rise to meet the ever-increasing demand for energy-efficient architectural commercial and residential glazing. High-performance IGUs typically comprise two, three, or four individual transparent panes securely spaced apart by a spacer made of stainless steel, aluminum, plastic, silicone, etc. Some IGUs employ one or more panes coated with low-emissivity solar-control coatings, most exclusively deposited on a surface facing inside the IGU for longevity, and are filled with inert gas, such as argon (Ar), or krypton (Kr), or their mixtures without and with air. Spacers are usually appropriately filled [EP1056919A1] or integrated with a desiccant (such as in the case of reactive thermoplastic warm edge spacer systems [U.S. Pat. No. 9,085,708B2, DE10311830A1, https://www.hbfuller.com/en/markets/glass/4sg] to prevent the residual moisture within the gas-filled glazing interior between the panes from condensation on the surface of the panes at low temperatures, as well as to absorb any in-leakage during its service life. Additionally, desiccant-filled plastic spacers will often have a moisture barrier around their outermost surface, such as a metal foil, to retain gas tightness, thus improving overall energy efficiency. Further, the panes in an IGU are structurally held together with a sealant such that the sealant adheres to the glass panes and the metal foil, as well as serving as another permeation barrier to ambient air and loss of the inert gas. The interior and exterior panes are typically made of relatively thick glass to ensure their good mechanical and chemical durability as well as to provide the appeal of glass from both inside and outside the building. In some IGUs, the middle pane (in case of a triple-pane IGU) or panes (in case of a quadruple IGU)—also known as ‘center glass’—are made of thin glass or plastic to reduce total weight of the unit. In the present invention, panes made of plastic are referred to as “polymeric glass center panes”.

Extruded spacers are known in the art and typically have a close to rectangular cross-section. The elastic nature of spacers helps in accommodating the relative deformation of the constituents of an IGU caused by the difference in their coefficients of thermal expansion. U.S. Pat. No. 9,873,820B2, for example, discloses a two-part spacer-sealant structure designed to accommodate thermal expansion and contraction of space between multiple panes while adhering the panes to the IGU frame. U.S. Pat. No. 6,355,328B1 and US20140356557A1 describe undulating spacer structures to mitigate deformations of an IGU.

IGUs comprising at least one polymeric glass pane made of an engineering plastic material, such as polycarbonate (PC), polymethyl methacrylate (PMMA), or polyethylene terephthalate (PET), have been disclosed in, e.g., [DK1354103T6]. In addition to a lighter compared to glass weight/density and potentially lower cost, plastics-particularly PMMA-offer high optical transparency, good thermal insulation, and better shatter resistance. To improve their thermal insulation performance, polymeric glass panes, just like regular glass panes, may be coated with low-emissive solar-control coatings [CA2375256; U.S. Pat. No. 5,028,759A; US20100257815A1]. Such coatings typically employ one or more thin layers of pure silver (Ag) or a corrosion-resistant silver alloy [https://doi.org/10.1016/j.mssp.2015.02.051; https://doi.org/10.1016/j.optmat.2023.113807].

Spacers designed to accommodate center glass, such as in triple- or quadruple-IGUs, are also known in the art. An example design of such a spacer is shown in FIG. 1A. Having one or more circumferential grooves in the middle of the spacer (FIG. 1B) allows accommodating one or more center panes in an IGU (FIG. 1C) without the need for additional spacers, thus avoiding the formation of additional failure/seal areas compared to a double-pane IGU. Such a spacer, for example, is disclosed in US20220316264A1 and, in addition to the center groove situated within its spacer body, comprises a sealant, optionally separated from the spacer body with a moisture barrier made, for example, of aluminum foil. The spacer body comprises a cavity comprising a base and a neck. The neck of the cavity is designed to compressively hold the center glass in place without the need of an adhesive. The cavity is not designed to redistribute the excessive pressure exerted by a polymeric glass center pane.

Spacer of US20170152701A1 comprises a groove filled with an insert made of ethylene propylene diene rubber to hold the center glass in place and accommodate its deformation transversely, i.e., along the direction perpendicular to the large surface of the pane. This, for example, reduces pressure on the profile of the spacer during the pane' lateral expansion and contraction at varying temperatures, which, at the dimensions of the thickness of the glass, is very small.

When a polymeric glass pane is used as center glass in a triple- or quadruple-IGU, it tends to expand at elevated temperatures more than glass due to its higher than the glass' coefficient of thermal expansion (CTE). This leads to greater pressure exerted by the polymeric glass pane on other IGU components in addition to the pressure created by the pane on the bottom portion of the IGU due to the gravitational load. For large IGUs such additional localized pressure may be quite significant. Traditional spacers comprise a sealant—an adhesive component typically made of a butylated polymer or silicone to provide thermal insulation and to adhere to the glass panes. Unfortunately, this class of materials does not offer sufficient flexibility and compressibility to address the problem of localized excessive pressure.

DE102019121690A1 discloses a compressible spring-like projection at the edge of the center pane to securely hold the pane in place during its compression/expansion. Using such a projection, however, does not relieve the localized pressure exerted by an expanding polymeric pane.

Cavities of a variety of shapes were suggested in US20140356557A1 to mitigate the deformation of spacer parts, but like in US20170152701A1, the design of such cavities was limited to transversal deformation. Besides, US20170152701A1 was limited to a spacer accommodating only two panes.

Therefore, solutions to mitigate the pressure from polymeric glass panes expanding longitudinally, i.e., in a direction parallel to their surface have not been developed in prior art. At the same time, such pressure may be significant and may, during considerable expansion, cause catastrophic damage to, e.g., the moisture barrier, thus compromising its moisture blocking properties or compromise the adhesion between the sealant-adhesive structure and the glass panes.

It would be desirable, therefore, to provide a spacer design suitable to accommodate the thermal expansion of a polymeric glass center pane in a multi-pane IGU to prevent the physical damage to the IGU components due to its linear deformation in a direction parallel to the surface of its panes.

### BRIEF DESCRIPTION OF THE INVENTION

The present invention solves the problem of the excessive localized pressure exerted by the linear deformation of the polymeric glass center pane or panes on other constituents of a multi-pane insulating glass unit (IGU), such as the moisture barrier or the adhesion joints between the spacer and the glass panes.

In the first aspect of the invention, a spacer is provided comprising a pressure-relief cavity formed during the extrusion process. The cavity is preferably situated within the spacer body between the edge of the polymeric glass pane and the nearest surface of the sealant. Alternatively, the cavity may be located within the sealant. The cavity may be situated symmetrically or asymmetrically around the spacer and in respect to the center pane or panes. The cavity accommodates the strain/elongation and distributes the pressure arising due to the elongation over a wider area, thus substantially alleviating the stress and preventing catastrophic damage to the moisture barrier or the bond between the glass pane and the sealant. The cavity provides an elastic response to external force, i.e., it deforms under pressure when the polymeric pane expands and resumes its original shape when the pane contracts.

The cavity may be made hollow or filled with a compressible material, such as aerated foam. The cavity may or may not contain desiccant. In addition to alleviating the pressure, the cavity may also be beneficial to reducing the heat transfer across the spacer due to its lower density compared to the material of the spacer body or the sealant.

In addition to the one or more polymeric glass center panes, the spacer of the present invention may also accommodate a polymeric pane situated on the innermost side of the IGU, thus replacing a conventionally used glass pane facing the building interior. The rationale behind such a configuration is that the indoor surface of an IGU is typically exposed to a relatively constant room temperature and does not undergo any significant thermal expansion/contraction. The spacer in such a configuration, therefore, may or may not comprise an additional pressure-relief cavity at or in the vicinity of the edge of said innermost polymeric glass pane of the IGU.

One or more center polymeric glass panes may be coated with a solar-control coating on at least one of its/their surface(s). The coating preferably comprises one or more silver based or silver-alloy based functional layers sandwiched between thin dielectric layers. Alternatively, the functional layer or layers may comprise other conductive transparent materials, e.g., transparent conductive oxides, such as indium-tin-oxide, tin oxide, indium oxide, zinc oxide, or a combination thereof. In yet other alternative designs, the solar-control coating may comprise a thin at least partially transparent non-silver-based metal layer or layers, such as Ni, NiCr, Cu, Al, Ti, etc., or a nitride or oxynitride thereof.

The corners of the polymeric glass pane may be shaped with external chamfer or external filet thereby mitigating linear expansion diagonally as well as point pressure loading on the spacer system.

The cavity may have a cross-section of any shape suitable to relieve the pressure exerted during the linear expansion of the polymeric glass pane. For example, the cavity may have a semi-circular cross-section. The cavity is longitudinal and circumferential, i.e., runs continuously along the entire perimeter of the IGU. The cross-sectional diameter of the cavity is from about 1 mm to about 50 mm, and preferentially between 2 mm to 10 mm.

The cavity of the present invention may be used for various spacer designs, present and future alike. For instance, it may be used in a spacer comprising a non-reactive and reactive sealant types [U.S. Pat. No. 9,085,708B2]. Examples of reactive sealant include hydrogenated polybutadiene, poly-α-olefins, and silane-functional polyisobutylene. Examples of non-reactive sealant materials include butyl rubbers, poly-α-olefins, diene polymers, polybutene or styrene block copolymers.

In a second aspect of the present invention, therefore, a spacer is provided comprising a compressible accommodating member (CAM) formed during the extrusion process. An essential difference between the CAM and the pressure-relief cavity is that the CAM at least partially separates individual layers of a spacer. In the case of the spacer of U.S. Pat. No. 9,085,708B2, for instance, the CAM may separate the reactive and non-reactive parts of the sealant to provide a relief of the pressure in longitudinal direction during the polymeric pane expansion/contraction. The CAM is filled with a compressible material and may or may not additionally comprise a filled or hollow pressure-relief cavity.

The spacer of the present invention is not limited to “soft” spacer designs, i.e., the designs comprising a soft spacer body, a sealant, and a moisture barrier made of thin foils. The concept of pressure-relief cavity and the CAM may also apply to redistributing excessive stress caused by a polymeric glass pane expansion/contraction in more rigid spacers, such as those made of metal [https://www.tecnoglass.com/products/insulating-glass/spacers/] or a material reinforced with metal within its body, rigid plastic [https://www.swisspacer.com/en-us], etc.

Polymeric glass center pane or panes may be made of polycarbonate (PC), polymethyl methacrylate (PMMA), polyethylene terephthalate (PET), etc. Their thickness may range from about 1 to about 6 mm. The preferred material for the spacer body is silicone. Other suitable materials, such as rubber or ethylene propylene diene monomer (EPDM)—a durable, flexible, and UV-tolerant material—may alternatively be used. The spacer body may comprise a desiccant absorbing the residual moisture in the space between the panes. Examples of desiccant materials include silica gel, calcium oxide, zeolite, molecular sieve, etc. A thin moisture barrier may be used between the spacer body and the sealant. The preferred material for the barrier is aluminum foil. Other metal foils or a plastic film coated with metal may be used alternatively.

The sealant can preferably be made of a butylated polymer—butyl rubber or polyisobutylene—which possess both excellent thermal insulating properties and sufficient adhesiveness to glass panes. Other sealant material choices include ethylene-propylene polymer, polyolefin rubber, silicone, urethane, or a mixture thereof, where the sealant may also provide moisture barrier properties.

In the preferred embodiment, the pressure-relief cavity has a semi-circular cross-section, and its inner wall is the local edge of the spacer body. The wall of the cavity faces either the sealant (if moisture barrier separating the spacer body from the sealant is absent) or the moisture barrier. The cavity is symmetrically aligned with the plastic center pane along the entire perimeter of the IGU, such as to dissipate the pressure exerted by the pane during its thermal deformation. At the bottom of the IGU, for example, the pressure-relief cavity helps to distribute the deformation caused by the pane expansion over a wider area, thus preventing structural damage.

In an embodiment, the cavity is formed within the spacer body and is separated from the sealant by the material of the spacer body.

In an embodiment, the cavity is formed at the edge of the sealant and faces the IGU frame.

In an embodiment, the cavity is filled with air.

In an embodiment, the cavity is filled with a material compositionally different from that of the spacer body or the sealant.

In an embodiment, the spacer has a hybrid design, i.e., it is made of a metal or plastic with reduced thickness at the edge facing the polymeric glass pane—to lower its total weight—and is filled with spacer body comprising the cavity.

In an embedment, the spacer is a reactive sealant warm edge spacer comprising a CAM with the cavity.

In an embodiment, the spacer comprises the number of cavities equal to the number of polymeric center glass panes.

In an embodiment, more than one pressure-relief spacer is used in a multi-pane IGU.

In an embodiment the cavity is situated symmetrically about the spacer width in correspondence to the center pane being symmetrically situated between the exterior and interior panes of glass.

In an embodiment the cavity is situated asymmetrically about the spacer so as to position the center pane asymmetrically, resulting in asymmetric cavity widths in order to achieve desired thermal and radiative energy transmission properties of the overall IGU.

In an embodiment, the outer glass panes comprise laminated glass for safety applications.

In an embodiment, one of the outer panes is polymeric glass—for example, the outermost pane is glass while the innermost pane is polymeric glass. The spacer may or may not comprise a pressure-relief cavity at or in the vicinity of the edge of said polymeric pane at the innermost side of the IGU.

In an embodiment, the outermost and innermost panes are polymeric glass panes. Such a configuration may be especially useful for ultra-lightweight IGU designs.

### BRIEF DESCRIPTION OF THE DRAWINGS

The present invention can be understood by considering the following drawings and the legends for the reference numerals presented further below:

FIG. 1A is a schematic representation of a prior art spacer comprising the spacer body with a groove for center pane, a sealant, and a moisture barrier.

FIG. 1B is a schematic representation of the top and bottom portions of a triple-pane insulating glass unit (IGU) comprising spacer of FIG. 1A.

FIG. 1C is a schematic representation of a full cross-sectional view of triple-pane IGU comprising prior art spacer of FIG. 1A.

FIG. 2A is a schematic representation of a spacer comprising a pressure-relief cavity at the edge of the spacer body according to the present invention in the case there is no pressure exerted by thermal expansion of the polymeric glass center pane. The cavity is situated symmetrically about the spacer and in respect to the center pane.

FIG. 2B is a schematic representation of a spacer comprising a pressure-relief cavity at the edge of the center body according to the present invention in the case when additional pressure is exerted by thermal expansion of the polymeric glass center pane. The cavity is situated symmetrically about the spacer.

FIG. 2C is a schematic representation of a spacer comprising a pressure-relief cavity at the edge of the spacer body according to the present invention in the case there is no pressure exerted by thermal expansion of the polymeric glass center pane. The cavity is situated asymmetrically about the spacer and in respect to the center pane.

FIG. 2D is a schematic representation of a spacer comprising a pressure-relief cavity at the edge of the spacer body according to the present invention in the case when additional pressure is exerted by thermal expansion of the polymeric glass center pane. The cavity is situated asymmetrically in respect to the center pane.

FIG. 3A is a schematic representation of a spacer comprising a pressure-relief cavity at the edge of the sealant according to the present invention in the case there is no pressure exerted by thermal expansion of the polymeric glass center pane.

FIG. 3B is a schematic representation of a spacer comprising a pressure-relief cavity at the edge of the sealant according to the present invention in the case when additional pressure is exerted by thermal expansion of the polymeric glass center pane.

FIG. 4 is a schematic representation of a spacer comprising a pressure-relief cavity within the spacer body according to the present invention.

FIGS. 5A-5D are a schematic representation of alternative shapes of the pressure-relief cavity at the edge of the spacer body.

FIG. 6A is a schematic representation of a spacer comprising a sealant and a rigid body shell filled with desiccant according to prior art.

FIG. 6B-6D is a schematic representation of the spacer of FIG. 6A comprising, according to the present invention, a pressure-relief cavity and a separator of various shapes.

FIG. 7A is a schematic representation of the spacer of FIG. 6A of prior art further comprising, according to the present invention, a compressible accommodating member comprising a pressure-relief cavity.

FIG. 7B is a schematic representation of the spacer of FIG. 7A further comprising a separator at the bottom of the groove.

FIG. 7C is a schematic representation of the spacer of FIG. 7A further comprising a groove with tooth-shaped walls to securely hold the polymeric glass center pane in place.

FIG. 8A is a schematic representation of a spacer according to prior art comprising a non-reactive and reactive sealant.

FIG. 8B is a schematic representation of the spacer of FIG. 8A additionally comprising, according to the present invention, a compressible accommodating member between the non-reactive and reactive sealant.

FIG. 8C is a schematic representation of the spacer of FIG. 8B further comprising, according to the present invention, a pressure-relief cavity situated within its compressible accommodating member.

FIG. 9A is a schematic representation of possible process of making spacer of FIG. 8B by extruding two symmetric halves of the spacer and then adhering them to the center pane.

FIG. 9B is a schematic representation of possible process of making spacer of FIG. 8B by extruding two asymmetric halves of the spacer and then adhering them to the center pane.

FIG. 9C is a schematic representation of possible process of making spacer of FIG. 9A further comprising a pressure-relief cavity.

FIG. 10A is a schematic representation of an insert comprising a pressure-relief cavity and teeth-shaped walls.

FIG. 10B is a schematic representation of a spacer similar to that of FIG. 9A but comprising an insert of FIG. 10A.

FIG. 11 is a schematic representation of a quadruple-pane IGU comprising a spacer according to the present invention comprising two circumferential pressure-relief cavities. One surface of one of the two polymeric glass center panes is coated with a low-E solar-control coating.

The accompanying drawings, which are incorporated in and form a part of this description, illustrate various embodiments of the invention, and together with the description, illustrate the principles of the invention, and enable those skilled in the art to make and use the invention.

Definition of the Reference Numerals used in the Drawings

| | |
|---|---|
| 100 | Spacer comprising a sealant and |
| | spacer body according |
| | to prior art |
| 110, 210, 310, 410, 510, 610, 710, 1110 | Spacer body |
| 120, 220, 320, 420, 520, 620, 720, 820, | Sealant |
| 920, 1020, 1120 | |
| 125, 225, 625, 725 | Groove for center pane |
| 130, 230, 330, 430, 530, 830, | Center pane |
| 930, 1030, 1130 | |
| 834, 934 | Reactive sealant |
| 736, 836, 936 | Compressible accommodating |
| | member |
| 140, 240, 340, 440, 540, 1140 | Moisture barrier |
| 150 | A triple-pane IGU according |
| | to prior art |
| 1152 | A quadruple-pane IGU |
| | comprising pressure-relief |
| | cavities according to |
| | the present invention |
| 160, 260, 360, 460, 560, 860, 960, | First glass pane |
| 1060, 1160 | |
| 1162 | Coated polymeric glass center |
| | pane |
| 164, 1164 | Solar-control coating |
| 170, 270, 370, 470, 570, 870, 970, | Second glass pane |
| 1070, 1170 | |
| 674, 774 | Metal or plastic shell |
| 778 | Groove with teeth-shaped walls |
| 190, 290, 390, 490, 590, 890, 990, | Glazing interior |
| 292, 392 | Depiction of pressure exerted on |
| | IGU components due to thermal |
| | expansion of center pane |
| 693, 793 | Separator |
| 294, 394, 494, 594, 694, 794, 894, | Pressure-relief cavity |
| 994, 1094, 1194 | according to |
| | the present invention |
| 396 | Example depiction of |
| | deformation of moisture |
| | barrier due to point |
| | loading |
| 1098 | Insert |
| 1099 | Teeth-shaped wall of the insert |

### DETAILED DESCRIPTION

A detailed description is provided below to facilitate a thorough understanding of the disclosed embodiments and connections thereof. The description is not limited to any particular example included herein.

Various embodiments and aspects of the disclosure will be described with reference to the details discussed below. The following description and drawings are illustrative of the disclosure and are not to be construed as limiting the disclosure. Numerous specific details are described to provide a thorough understanding of various embodiments of the present disclosure. The Figures are not to scale. Further, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistical dimensions may exist outside this region. It is not the intention to exclude embodiments such as these from the present disclosure. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

The following terminology is used to describe the subject of the invention. A glazing is an article comprising at least one layer of a transparent material which serves to provide for the transmission of light and/or to provide for viewing of the side opposite the viewer and which is mounted in an opening in a building, vehicle, wall or roof or other framing member or enclosure. An insulating glass unit (IGU) is a glazing comprising two or more transparent panes spaced apart with the help of a spacer.

A polymeric glass pane is a pane which, unlike a traditional glass pane, comprises a polymeric (or plastic) material, such as polycarbonate (PC), polymethyl methacrylate (PMMA), polyethylene terephthalate (PET), etc. Its thickness may range from about 1 to about 6 mm.

The coated polymeric pane situated within the various embodiments described in the present invention undergoes thermally induced strain as temperature rises or drops. The new spacer configuration accommodates the thermally induced stresses thereby mitigating the forces and strains on the various structural elements/seals of the IGU and thus damage to and breach of the integrity of the IGU. In general, the coated polymeric pane, including the coating, as well as the various structural elements will experience certain stresses (compressive, tensile) subject to the properties of the various interfacing materials comprising the IGU, such that the structural elements operate within the elastic (reversible) regime upon thermal swings above or below nominal ambient temperature of the IGU.

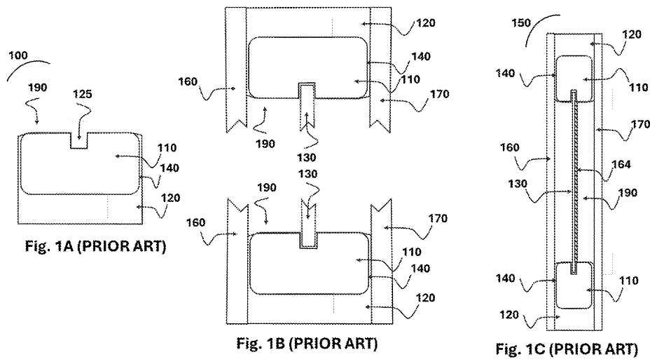

A spacer 100 is a strip of material that separates and supports glass panes 160 and 170, thus creating an airtight cavity 190 that maintains gas between the panes for improved thermal insulation, as depicted in FIGS. 1A-1C representing Prior Art. The preferred material for the spacer body 110 is silicone. Other suitable materials, such as foam, rubber or ethylene propylene diene monomer (EPDM)—a durable, flexible, and UV-tolerant material—may alternatively be used. Spacer body 110 may comprise a desiccant absorbing the residual moisture in the space 190 between the panes 160 and 170. Examples of desiccant materials include silica gel, calcium oxide, zeolite, molecular sieve, etc. A thin moisture barrier 140 may be used between the spacer body 110 and the sealant 120. The preferred material for the barrier is aluminum foil. Other metal foils or a plastic film coated with metal may be used alternatively.

The sealant is an integrated part of an IGU 150 and can preferably be made of a butylated polymer—butyl rubber or polyisobutylene—which possess both excellent thermal insulating properties and sufficient adhesiveness to glass panes. Other sealant material choices include ethylene-propylene polymer, polyolefin rubber, silicone, urethane, or a mixture thereof, where the sealant may also provide moisture barrier properties. A sealant for an IGU comprising central pane 130 may have a groove 125 to securely accommodate the pane 130.

A solar-control coating 164 is a thin-film infrared (IR) reflecting coating providing partial reduction in the amount of solar radiative heat. The coating generally also exhibits low emissivity (low-E) properties, namely, providing high reflectivity in the mid-infrared range (ambient/room heat). The coating 164 typically comprises at least one silver-based thin layer. Examples include a pure silver layer, and a layer of silver alloyed with other metals, such as, e.g., Cu and/or Al, or a bilayer—a combination thereof. Solar-control coating 164 is typically deposited on a surface of one or more of panes 160 and 170, such as it faces space 190 between the panes 160 and 170.

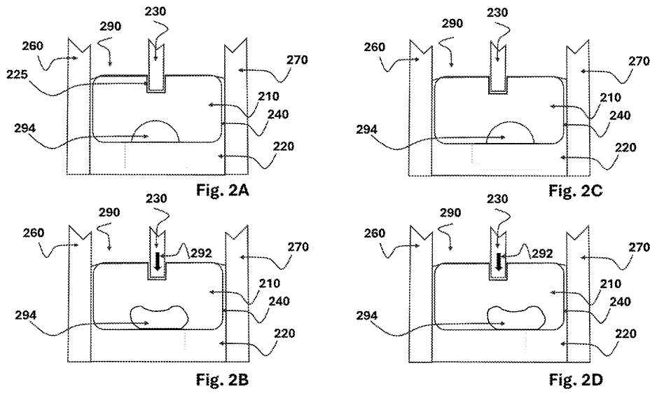

Referring to FIGS. 2A, 2B, 2C and 2D, in the first aspect of the present invention, a spacer for a multi-pane IGU comprises a pressure-relief cavity 294 to redistribute over a wider area the excessive localized pressure exerted by the linear deformation of the polymeric glass center pane 230 or panes on other constituents of a multi-pane insulating glass unit (IGU), such as the moisture barrier 240 or the adhesion joints between the spacer and the glass panes.

Cavity 294 may be formed during the extrusion process of making the IGU spacer. The cavity 294 is preferably located within the spacer body 210 between the edge of the polymeric glass center pane 230 and the nearest surface of the sealant 220. Alternatively, the cavity 294 may be located within the sealant 220. Cavity 294 may be situated symmetrically (FIG. 2A) or asymmetrically (FIG. 2C) around the spacer and in respect to the pane 230. The cavity 294 promotes a uniform distribution of excessive pressure over a wider area (FIGS. 2B and 2D), thus substantially alleviating stress and preventing catastrophic damage to the moisture barrier 240 or the pane/sealant bond. The cavity 294 provides an elastic response to external force 292, i.e., it deforms under pressure when the pane 230 expands and resumes its original shape when the pane 230 contracts. The cavity 294 may be made hollow or filled with a compressible material, such as aerated foam. The cavity 294 may or may not contain desiccant. In addition to alleviating the excessive pressure, the cavity 294 may also be beneficial to reducing the heat transfer across the spacer 210 due to its lower density compared to the material of the spacer 210.

The cavity 294 may have a cross-section of any shape suitable to relieve the pressure exerted during the linear expansion of the polymeric pane 230. The cavity 294 is longitudinal and circumferential, i.e., runs continuously along the entire perimeter of the IGU. The cross-sectional diameter of the cavity 294 is from about 1 mm to about 50 mm, and preferentially between 2 mm to 10 mm.

The sealant 220 can be preferably made of a butylated polymer—butyl rubber or polyisobutylene—which possess both excellent thermal insulating properties and sufficient adhesiveness to glass panes. Other sealant material choices include ethylene-propylene polymer, polyolefin rubber, silicone, urethane, or a mixture thereof, where the sealant may also provide moisture barrier properties.

The preferred material for the spacer body 210 of the present invention is silicone. Other suitable materials, such as rubber or ethylene propylene diene monomer (EPDM)—a durable, flexible, and UV-tolerant material—may alternatively be used. The spacer body 210 may comprise a desiccant absorbing the residual moisture in the space between the panes. Examples of desiccant materials include silica gel, calcium oxide, zeolite, molecular sieve, etc. A thin moisture barrier 240 may be used between the spacer body 210 and the sealant 220. The preferred material for the barrier is aluminum foil. Other metal foils or a plastic film coated with metal may be used alternatively.

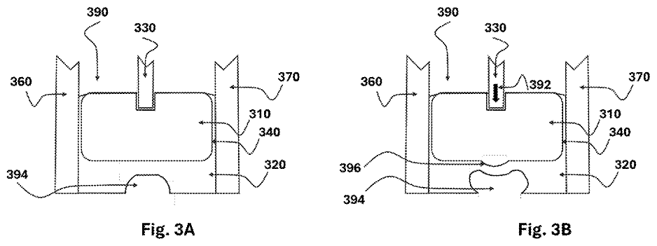

An alternative location for cavity 394 at the outer edge of the sealant 320 with and without the force 392 exerted by the polymeric glass center plane 330 is shown in FIGS. 3A and 3B.

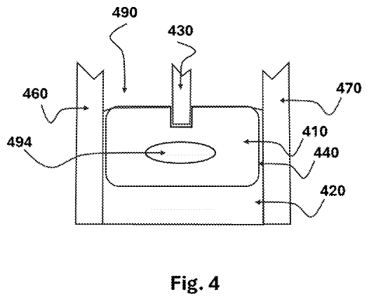

From the manufacturing point of view, making a cavity at an edge of the sealant or the spacer body during the extrusion process is preferred. Alternatively, the cavity 494 may be located within the sealant 420 and may have a different cross-sectional shape, such as an oval, as shown in FIG. 4.

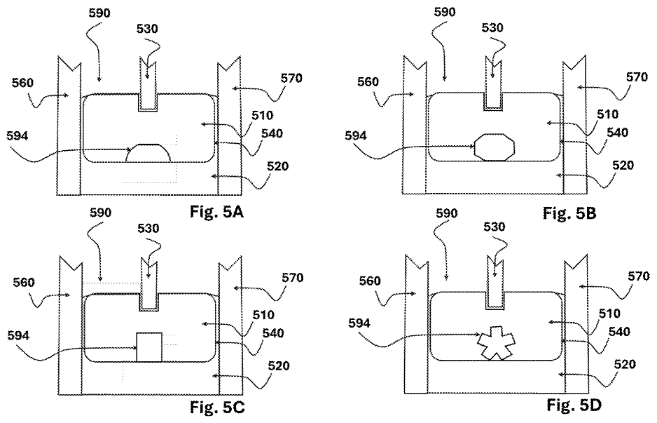

Other shapes of cavity 594 are depicted in FIGS. 5A-5D.

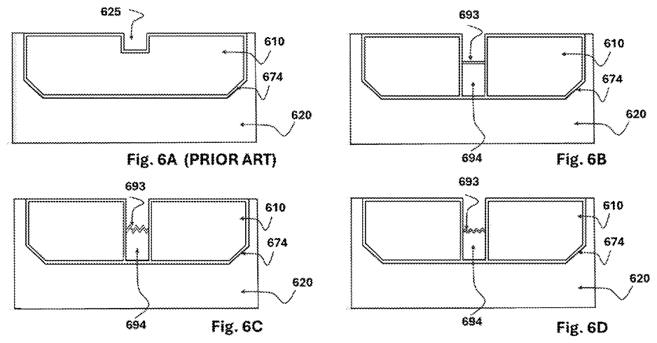

The cavity of the present invention may be accommodated in various spacer types. FIG. 6A depicts, for example, a spacer of prior art comprising a rigid shell 674 filled with spacer body 610 and comprising a groove 625 to securely hold in place a polymeric glass center pane (not shown). Such spacers are commercially available (https://www.swisspacer.com/en-us; https://www.tecnoglass.com/products/insulating-glass/spacers/) and are designed for enhanced rigidity of an IGU. The spacer body 610 may or may not comprise desiccant. FIG. 6B depicts the pressure-relief cavity 694 of the present invention separated from the groove 625 with a flat separator 693 made of a thin flexible material, such as thin metal or plastic. Separator 693 may also have alternative cross-sectional shapes, such as those with an undulating profile depicted in FIGS. 6C and 6D.

In a second aspect of the present invention, a spacer comprises a compressible accommodating member (CAM) formed during the extrusion process. An essential difference between the CAM and the pressure-relief cavity is that the CAM at least partially separates individual layers of a spacer. In the case of the spacer of U.S. Pat. No. 9,085,708B2, for instance, the CAM may separate the reactive and non-reactive parts of the sealant to provide a relief of the pressure in longitudinal direction during the polymeric pane expansion/contraction. The CAM is filled with a compressible material and may or may not additionally comprise a filled or hollow pressure-relief cavity.

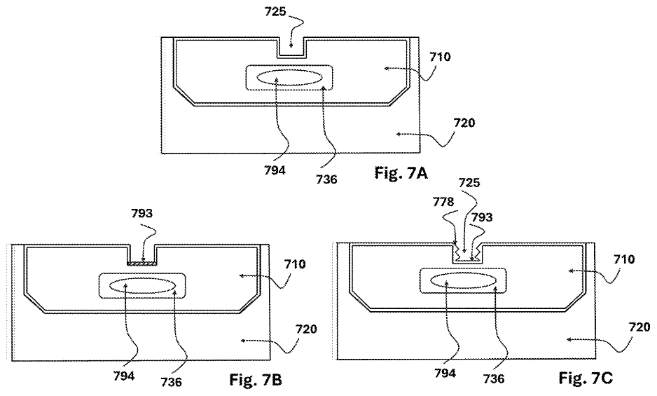

FIG. 7A shows the design wherein cavity 794 is enclosed within a CAM 736. Cross-section of the CAM 736 may or may not have the same shape as that of the cavity 794. Cavity 794 and the CAM 736 have different densities and may or may not comprise the same material type. For example, they may both comprise the same type of foam aerated at different levels, thus having different levels of compressibility. Alternatively, cavity 794 may be hollow (filled with air or gas) while the CAM 736 may have a greater density. The CAM 736 may optionally comprise desiccant. The bottom of groove 725 of a spacer of the present invention may comprise separator 793 in the form of a thin elastic membrane which may or may not be in direct contact with CAM 736. Separator 793 may be made of thin metal or plastic. The walls 778 of groove 725 may have a teethed profile to compressively hold in place the polymeric glass center pane (not shown).

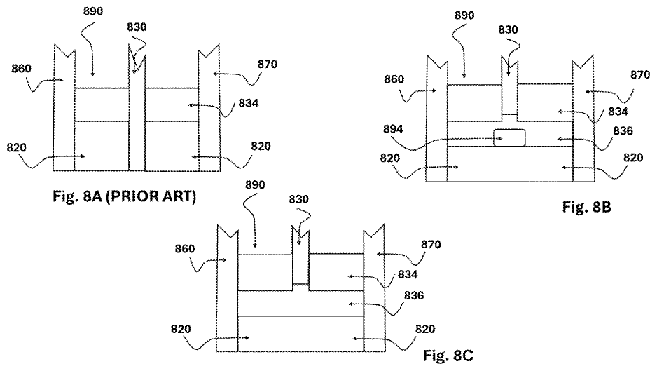

FIG. 8A depicts a spacer design according to prior art (e.g., U.S. Pat. No. 9,085,708B2) comprising a non-reactive sealant 820 and reactive sealant 834 intendent to securely and in a flexible manner space apart the glass panes 860 and 870 as well as the polymeric glass center pane 830. In the spacer design, according to the present invention, shown in FIG. 8B, CAM 836 is introduced between the non-reactive sealant 820 and reactive sealant 834. The CAM 776 may be made of foam. Cam 836 occupies the entire space between the two sealant types 820 and 834 along the perimeter of the IGU and comprises a pressure-relief cavity 894 symmetrically situated in respect to the polymeric glass center pane 834. Cavity 894 may be alternatively introduced within the non-reactive sealant 820 or reactive sealant 834. An alternative spacer design of FIG. 8C, according to the present invention, comprises the CAM 836 containing no additional pressure-relief cavity.

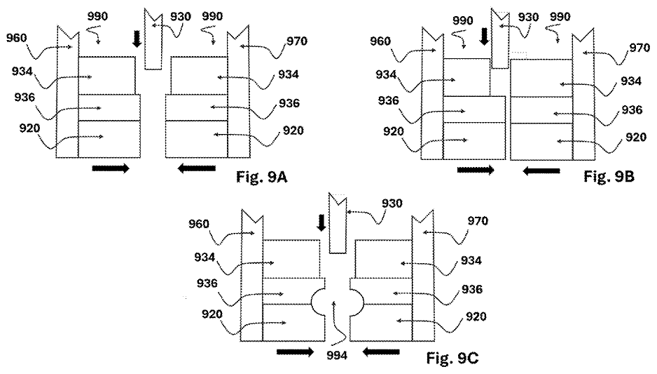

FIG. 9A is a schematic representation of an embodiment of a process of making the spacer of FIG. 8B by extruding its two symmetric halves—each comprising a non-reactive sealant 920, reactive sealant 934, a CAM 936, and either of the glass panes, 960 or 970,—and then adhering them to the center pane 930.

FIG. 9B is a schematic representation of an embodiment of a process of making spacer of FIG. 8B by extruding two asymmetric halves of the spacer—each comprising a non-reactive sealant 920, a reactive sealant 934, a CAM 936, and a glass pane 960 or 970—and then adhering them to the center pane 930. FIG. 9C is a schematic representation of an embodiment of a process of making a spacer using two symmetrical halves and further comprising a pressure-relief cavity 994.

One or more polymeric glass center panes secured by a spacer of the present invention may be coated with a solar-control coating on at least one of its/their surface(s). The coating preferably comprises one or more silver based or silver-alloy based functional layers sandwiched between thin dielectric layers. Alternatively, the functional layer or layers may comprise other conductive transparent materials, e.g., transparent conductive oxides, such as indium-tin-oxide, tin oxide, indium oxide, zinc oxide, or a combination thereof. In yet other alternative designs, the solar-control coating may comprise a thin at least partially transparent non-silver-based metal layer or layers, such as Ni, NiCr, Cu, Al, Ti, etc., or a nitride or oxynitride thereof. The preferred deposition method for a solar-control coating is magnetron sputtering, although other methods, such as chemical vapor, plasma-enhanced, or electron-beam deposition, etc., may also be used.

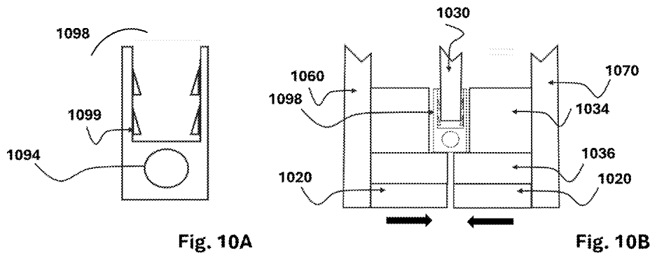

FIG. 10A demonstrates an insert 1098 comprising a pressure-relief cavity 1094 and teeth-shaped walls 1099.

FIG. 10B demonstrates an example of using insert 1098 in the reactive sealant to prevent the pane 1030 from moving away from the center of the spacer during expansion/contraction. Similar to FIG. 9A, arrows represent the adhering step of a possible version of the manufacturing process.

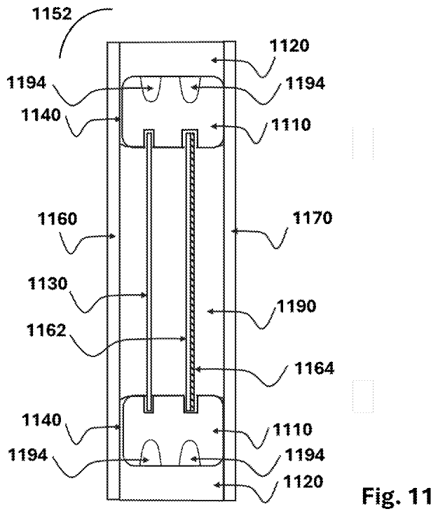

FIG. 11 demonstrates a quadruple-pane IGU 1152 comprising a spacer according to the present invention comprising two circumferential pressure-relief cavities 1194. One surface of an additional polymeric glass center pane 1162 is coated with a low-E solar-control coating.

In addition to the one or more polymeric center glass panes 1130, the spacer of the present invention may also accommodate a polymeric pane situated on the innermost side of the IGU, thus replacing the conventionally used glass pane 1160 or 1170, or both. The rationale behind such a configuration is that the indoor surface of the IGU is typically exposed to a relatively constant room temperature and does not undergo any significant thermal expansion/contraction. The spacer in such a configuration, therefore, may or may not comprise an additional pressure-relief cavity at or in the vicinity of the edge of said innermost polymeric pane of the IGU.

The corners of one or more polymeric glass center panes may be shaped with external chamfer or external filet thereby mitigating linear expansion diagonally as well as point pressure loading on the spacer system.

### Example 1

Example one is a spacer of FIG. 2A comprising a spacer body 210, a sealant 220, a moisture barrier 240, and a pressure-relief cavity 294. The cross-section of the cavity 294 has a semicircular shape. The cross-sectional diameter of the cavity is from about 1 mm to about 50 mm, and preferentially between 2 mm to 10 mm. The cavity 294 is hollow and is symmetrically situated in respect to the polymeric glass center pane 230 at the edge of the spacer body 210. The cavity 294 is in direct contact with the moisture barrier 240. The moisture barrier 240 is made of aluminum foil.

### Example 2

Example two is similar to Example one except that the pressure-relief cavity 294 is situated asymmetrically in respect to the polymeric glass center pane 230 at the edge of the spacer body 210, as shown in FIG. 2C.

### Example 3

Example three is similar to Example one except that the cavity 394 has a modified semi-circular cross-sectional shape shown in FIG. 3A. The cavity 394 is situated symmetrically in respect to the polymeric glass center pane 330 at the outer edge of the sealant 320.

### Example 4

Example four is similar to Example one except that the cavity 494 has an oval cross-section shape and is situated within the spacer body 410 symmetrically in respect to the polymeric glass center pane 430, as shown in FIG. 4.

### Example 5

Example five is similar to Example one except that the cavity 594 has four different shapes in FIGS. 5A to 5D, for example a square cross-section shape in FIG. 5C and is situated at the outer edge of the spacer body 510 symmetrically in respect to the polymeric glass center pane 530, as shown in FIG. 5C.

### Example 6

Example six is a spacer depicted in FIG. 6B and comprising a sealant 620 and a rigid plastic shell 674 comprising spacer body 610. Cavity 694 is separated from the groove 625 with a thin separator 693 made of elastic plastic membrane. The spacer body 610 is filled with desiccant.

### Example 7

Example seven is similar to Example six except that the spacer body 710 comprises a compressible accommodating member (CAM) 776 comprising a pressure-relief cavity 794, as shown in FIG. 7C. Groove 725 comprises teeth-shaped compressible walls to securely hold a polymeric glass center pane as seen in FIG. 7C. The CAM 776 is made of foam. The cavity 794 is hollow. The spacer body is filled with desiccant.

### Example 8

Example eight is a spacer comprising a non-reactive sealant 820 made of a butylated polymer, a reactive sealant 834, and a CAM 836, as shown in FIG. 8B. The CAM 836 occupies the entire volume between the non-reactive sealant 820 and reactive sealant 834 and comprises a pressure-relief cavity 894 having a rectangular cross-section, as shown in FIG. 8B.

### Example 9

Example nine is a spacer comprising two halves (FIG. 9C), each comprising a non-reactive sealant 920, a reactive sealant 934, a CAM 936, and a pressure-relief cavity 994 and fabricated by adhering said two halves to each other and a center pane 930.

### Example 10

Example ten is a spacer comprising an insert 1098 (FIGS. 10A and B) comprising a pressure relief cavity 1094 and teeth-shaped walls 1099. Insert 1098 is introduced to the reactive sealant 1034 to prevent the center pane 1030 from moving away from the center of the spacer during its expansion/contraction.

### Example 11

Example nine is an IGU of FIG. 11 comprising two outer glass panes 1160 and 1170, an uncoated polymeric glass center pane 1030, an additional polymeric glass center pane 1162 coated with a solar-control coating 1164, and a spacer comprising a sealant 1020 and a spacer body 1110 comprising two pressure-relief cavities 1194, one for each polymeric glass center pane.

### EMBODIMENTS

The present disclosure provides an insulated glass unit (IGU) spacer, the spacer comprising:
a spacer body (210);
a sealant (220) adjacent to the spacer body (210);
at least one groove (225) centrally located on a first side of the spacer body (210) for accommodating at least one central pane (230);
at least one pressure-relief cavity (294) located on a second side of the spacer body (210) opposed to the first side of the spacer body (210) and having dimensions from about 1 mm to about 50 mm, and situated at a distance from the grove (225) from about 1 mm to about 30 mm, as measured from the center of the cavity to the nearest edge of the groove; and
the insulated glass unit spacer being configured to be located between a first pane (260) and a second pane (270) spaced from the first pane (260).

In an embodiment the at least one pressure-relief cavity (294) has dimensions from about 2 mm to about 10 mm.

In an embodiment the at least one pressure-relief cavity (294) is situated at a distance from the groove (225) from about 5 mm to about 15 mm as measured from the center of the cavity to the nearest edge of the groove.

In an embodiment the pressure-relief cavity (294) is situated within the spacer body (210).

In an embodiment the pressure-relief cavity (394) is situated within the sealant (320).

In an embodiment the pressure-relief cavity (294) is hollow.

In an embodiment the pressure-relief cavity (294) is filled with a compressible material.

In an embodiment the pressure-relief cavity (294) is situated symmetrically with respect to the groove (225).

In an embodiment the pressure-relief cavity (294) is situated asymmetrically with respect to the groove (225).

In an embodiment the pressure-relief cavity (294) has a semi-circular cross-sectional shape.

In an embodiment a moisture barrier (240) is provided between the spacer body (210) and the sealant (220) and is in contact with both the spacer body (210) and the sealant (220).

In an embodiment there is provided an insulated glass unit (IGU) spacer, the spacer comprising:
a sealant (620);
a rigid shell (674) comprising a spacer body (610) partially embedded in the sealant (620);
at least one groove (625) centrally located on one side of the rigid shell (674) for accommodating at least one central pane;
at least one pressure-relief cavity (694) having dimensions from about 1 mm to about 50 mm, and situated at a distance from the grove (625) from about 2 mm to about 30 mm, as measured from the center of the cavity to the nearest edge of the groove;
an elastic separator (693) situated between opposed walls of the groove (625) to form a cavity (694) separated from the groove (625) by the elastic separator (693); and
the insulated glass unit being configured to be located between a first pane (660) and a second pane (670) spaced from the first pane (660).

In an embodiment the at least one pressure-relief cavity (694) has dimensions from about 2 mm to about 10 mm and situated at a distance from the grove (625).

In an embodiment the at least one pressure-relief cavity (694) is situated at a distance from the grove (625) from about 5 mm to about 15 mm (as measured from the center of the cavity to the nearest edge of the groove).

In an embodiment the separator (693) is made of a thin flexible material and has a flat or undulating profile.

In an embodiment the pressure-relief cavity (694) is hollow.

In an embodiment the pressure-relief cavity (694) is filled with a compressible material.

In an embodiment the spacer body (610) is filled with a desiccant.

In an embodiment the pressure-relief cavity (694) is situated symmetrically in respect to the groove (625).

In an embodiment the pressure-relief cavity (694) is situated asymmetrically in respect to the groove (625).

In an embodiment there is provided an insulated glass unit (IGU) spacer, the spacer comprising:
a non-reactive sealant (820);
a reactive sealant (834) adhered directly to a central pane (830);
at least one compressible accommodating member (CAM) (836), the CAM having a thickness from about 5 mm to about 100 mm, and situated at a distance from the central pane (830) from about 3 mm to about 30 mm, as measured from the center of the CAM to the nearest edge of the pane; and
the insulated glass unit being configured to be located between a first pane (860) and a second pane (870) spaced from the first pane (860).

In an embodiment the CAM (836) has a thickness from about 7 mm to about 20 mm and situated at a distance from the grove (625).

In an embodiment the CAM (836) is situated at a distance from the central pane from about 5 mm to about 15 mm as measured from the center of the cavity to the nearest edge of the groove.

In an embodiment the CAM (836) occupies the entire volume between the non-reactive sealant (820) and reactive sealant (834).

In an embodiment the CAM (836) occupies a partial volume between the non-reactive sealant (820) and reactive sealant (834) thus allowing the two sealants to meet outside the boundaries of the CAM (836).

In an embodiment the CAM (836) comprises a desiccant.

In an embodiment the CAM (836) comprises a pressure-relief cavity (894) having dimensions from about 1 mm to about 50 mm.

In an embodiment the CAM (836) comprises a pressure-relief cavity (894) having dimensions from about 2 mm to about 10 mm.

In an embodiment the pressure-relief cavity (894) is hollow.

In an embodiment the pressure-relief cavity (894) is filled with a compressible material.

In an embodiment the pressure-relief cavity (894) is situated symmetrically in respect to the pane (830).

In an embodiment the pressure-relief cavity (894) is situated asymmetrically in respect to the pane (830).

What is claimed is:

1. An insulated glass unit (IGU) spacer, the spacer comprising:
a spacer body;
a sealant adjacent to the spacer body;
at least one groove centrally located on a first side of the spacer body for accommodating at least one central pane;
at least one pressure-relief cavity located on a second side of the spacer body opposed to the first side of the spacer body and having dimensions from about 1 mm to about 50 mm, and situated at a distance from the grove from about 1 mm to about 30 mm, as measured from the center of the cavity to the nearest edge of the groove; and
the insulated glass unit spacer being configured to be located between a first pane and a second pane spaced from the first pane.

2. The spacer according to claim 1, wherein the at least one pressure-relief cavity has dimensions from about 2 mm to about 10 mm.

3. The spacer according to claim 1, wherein the at least one pressure-relief cavity is situated at a distance from the groove from about 5 mm to about 15 mm as measured from the center of the cavity to the nearest edge of the groove.

4. The spacer according to claim 1, wherein the pressure-relief cavity is situated within the spacer body.

5. The spacer according to claim 1, wherein the pressure-relief cavity is situated within the sealant.

6. The spacer according to claim 1, wherein the pressure-relief cavity is hollow.

7. The spacer according to claim 1, wherein the pressure-relief cavity is filled with a compressible material.

8. The spacer according to claim 1, wherein the pressure-relief cavity is situated symmetrically with respect to the groove.

9. The spacer according to claim 1, wherein the pressure-relief cavity is situated asymmetrically with respect to the groove.

10. The spacer according to claim 1, wherein the pressure-relief cavity has a semi-circular cross-sectional shape.

11. The spacer according to claim 1, wherein a moisture barrier is provided between the spacer body and the sealant and is in contact with both the spacer body and the sealant.

12. An insulated glass unit (IGU) spacer, the spacer comprising:
a sealant;
a rigid shell comprising a spacer body partially embedded in the sealant;
at least one groove centrally located in one side of the rigid shell for accommodating at least one central pane;
at least one pressure-relief cavity having dimensions from about 1 mm to about 50 mm, and situated at a distance from the grove from about 2 mm to about 30 mm, as measured from the center of the cavity to the nearest edge of the groove;
an elastic separator situated between opposed walls of the groove to form a cavity separated from the groove by the elastic separator; and
the insulated glass unit being configured to be located between a first pane and a second pane spaced from the first pane.

13. The spacer according to claim 12, wherein the at least one pressure-relief cavity has dimensions from about 2 mm to about 10 mm and situated at a distance from the grove.

14. The spacer according to claim 12, wherein the at least one pressure-relief cavity is situated at a distance from the grove from about 5 mm to about 15 mm (as measured from the center of the cavity to the nearest edge of the groove).

15. The spacer according to claim 12, wherein the separator is made of a thin flexible material and has a flat or undulating profile.

16. The spacer according to claim 12, wherein the pressure-relief cavity is hollow.

17. The spacer according to claim 12, wherein the pressure-relief cavity is filled with a compressible material.

18. The spacer according to claim 12, wherein the spacer body is filled with a desiccant.

19. The spacer according to claim 12, wherein the pressure-relief cavity is situated symmetrically in respect to the groove.

20. The spacer according to claim 12, wherein the pressure-relief cavity is situated asymmetrically in respect to the groove.

21. An insulated glass unit (IGU) spacer, the spacer comprising:
a non-reactive sealant;
a reactive sealant adhered directly to a central pane;
at least one compressible accommodating member (CAM), the CAM having a thickness from about 5 mm to about 100 mm, and situated at a distance from the central pane from about 3 mm to about 30 mm, as measured from the center of the CAM to the nearest edge of the pane; and
the insulated glass unit being configured to be located between a first pane and a second pane spaced from the first pane.

22. The spacer according to claim 21, wherein the CAM has a thickness from about 7 mm to about 20 mm and situated at a distance from the grove.

23. The spacer according to claim 21, wherein the CAM is situated at a distance from the central pane from about 5 mm to about 15 mm as measured from the center of the cavity to the nearest edge of the groove.

24. The spacer according to claim 21, wherein the CAM occupies the entire volume between the non-reactive sealant and reactive sealant.

25. The spacer according to claim 21, wherein the CAM occupies a partial volume between the non-reactive sealant and reactive sealant thus allowing the two sealants to meet outside the boundaries of the CAM.

26. The spacer according to claim 21, wherein the CAM comprises a desiccant.

27. The spacer according to claim 21, wherein the CAM comprises a pressure-relief cavity having dimensions from about 1 mm to about 50 mm.

28. The spacer according to claim 21, wherein the CAM comprises a pressure-relief cavity having dimensions from about 2 mm to about 10 mm.

29. The spacer according to claim 21, wherein the pressure-relief cavity is hollow.

30. The spacer according to claim 21, wherein the pressure-relief cavity is filled with a compressible material.

31. The spacer according to claim 21, wherein the pressure-relief cavity is situated symmetrically in respect to the pane.

32. The spacer according to claim 21, wherein the pressure-relief cavity is situated asymmetrically in respect to the pane.
